(19) United States
(12) Patent Application Publication
(10) Pub. No.: US 2026/0134611 A1
(43) Pub. Date: May 14, 2026

(54) System and Method for 3D Occupancy Grid Acquisition via LiDAR in Autonomous Driving

(71) Applicant: Yuping Wang, Santa Fe, NM (US)

(72) Inventor: Yuping Wang, Santa Fe, NM (US)

(21) Appl. No.: 18/945,488

(22) Filed: Nov. 12, 2024

(51) Int. Cl. G06T 15/08; G06T 15/06; G06T 17/20; G06V 10/762; G06V 20/52

(52) U.S. Cl. CPC G06T 15/08; G06T 15/06; G06T 17/20; G06V 10/762; G06V 20/52

(57) ABSTRACT

This invention provides a system and method for generating a dense, visibility-aware 3D occupancy grid from LiDAR data to enhance spatial perception in autonomous driving. The system comprises a voxel densification module that aggregates sequential LiDAR frames, a K-nearest neighbors algorithm for label propagation, and a mesh reconstruction process to fill sparse regions. An occlusion reasoning module classifies each voxel as occupied, free, or unobserved through LiDAR-based ray-casting. Additionally, camera image-guided refinement adjusts voxel states by aligning 3D voxel labels with 2D image pixels, ensuring accurate boundary representation and correcting for sensor noise. The resulting occupancy grid includes general objects outside predefined categories, enabling more robust obstacle detection. This system significantly improves autonomous navigation by enhancing object recognition, boundary accuracy, and overall environmental understanding.

### BACKGROUND OF THE INVENTION

Autonomous driving requires a high degree of spatial perception to understand the environment accurately and ensure safe navigation. A core challenge in robotic perception for autonomous vehicles is the generation of detailed 3D representations of the surrounding environment. Such representations are essential for identifying and classifying objects, navigating around obstacles, and predicting potential hazards. Traditional perception systems rely on 3D object detection techniques that use bounding boxes to represent the location and dimensions of objects in space. However, these bounding box methods suffer from several critical limitations, particularly in environments that are unstructured or contain objects with complex shapes.

Existing 3D object detection frameworks typically utilize pre-defined ontologies, meaning they are limited to recognizing objects within specific, pre-annotated categories. This restriction makes it challenging to account for “out-of-vocabulary” or general objects, which may not be explicitly annotated in training datasets but still pose a potential hazard to autonomous vehicles. Additionally, the bounding box approach fails to capture fine-grained geometric details, such as protruding features or irregular shapes, which are common in real-world environments. For instance, construction vehicles often have extending mechanical arms, and roadside objects like trash cans may have shapes that bounding boxes cannot accurately represent.

LiDAR (Light Detection and Ranging) technology is frequently used in autonomous driving for its ability to capture 3D data in diverse environmental conditions, but its point clouds are sparse, especially at greater distances. Sparse LiDAR data results in low-resolution occupancy grids that lack the density needed for precise object detection and classification. Consequently, autonomous systems using sparse LiDAR data are limited in their capacity to distinguish between occupied, free, and unobserved spaces, as well as to accurately classify objects based on their semantic properties.

To overcome these limitations, the present invention introduces a method to produce a high-resolution, dense 3D occupancy grid by processing and aggregating sequential LiDAR scans and camera images. This approach not only increases the spatial resolution of the occupancy grid but also addresses the inherent sparsity and occlusion issues found in traditional LiDAR-based methods. By integrating voxel densification, occlusion reasoning, and image-guided refinement, this invention enables autonomous systems to produce a more comprehensive and accurate 3D representation of their surroundings. The proposed system enhances the vehicle's ability to detect a wider range of objects, including general objects outside of pre-defined categories, thus improving the robustness and safety of autonomous navigation in complex, dynamic environments.

### SUMMARY OF THE INVENTION

This invention provides a system and method for acquiring a dense, visibility-aware 3D occupancy grid from LiDAR data, specifically designed to enhance the environmental perception of autonomous vehicles. The system addresses the limitations of existing 3D object detection and occupancy prediction methods, which often struggle with sparse data, limited object categorization, and an inability to capture complex object geometries.

The invention employs a multi-stage process for transforming sequential, sparse LiDAR scans into a dense 3D occupancy grid. This process includes voxel densification, occlusion reasoning, and image-guided refinement to ensure high spatial resolution and accurate semantic representation across all visible regions of the environment. Key innovations of this invention include: Voxel Densification through Multi-Frame Aggregation, Occlusion Reasoning using Ray-Casting Algorithms, Image-Guided Voxel Refinement for Enhanced Accuracy, General Object Detection and Representation.

The resulting 3D occupancy grid provides a dense, visibility-aware representation that enhances an autonomous vehicle's perception capabilities. By accurately modeling both the geometric and semantic aspects of the environment, including unstructured objects, the invention enables improved object detection, obstacle avoidance, and path planning. This method significantly improves the safety, reliability, and versatility of autonomous navigation, particularly in complex, real-world environments where traditional object detection approaches may fall short.

### BRIEF DESCRIPTION OF DRAWINGS

FIG. 1A: Illustrates a side view of a vehicle and annotates the hardware configuration: A 32 Beam LiDAR is mounted atop an autonomous driving vehicle. The LiDAR provides 360° horizontal, 40° vertical field of view to measure the surrounding environment into point clouds at ≤70 m range, ±2 cm accuracy. There are also four RGB Cameras with 1/1.8″ CMOS sensor, 1600×900 resolution, auto exposure and 120° FOV. The images from these four cameras provide 360° panoramic view.

FIG. 1B: Illustrates a top view of a vehicle.

FIG. 2: Illustrates the front view taking by the camera of the vehicle.

FIG. 3: Illustrates the point clouds measured from the LiDAR, overlaid on top of the camera image.

FIG. 4: Illustrates the acquired 3D occupancy grid around the vehicle using the camera image and LiDAR information in FIG. 2 and FIG. 3.

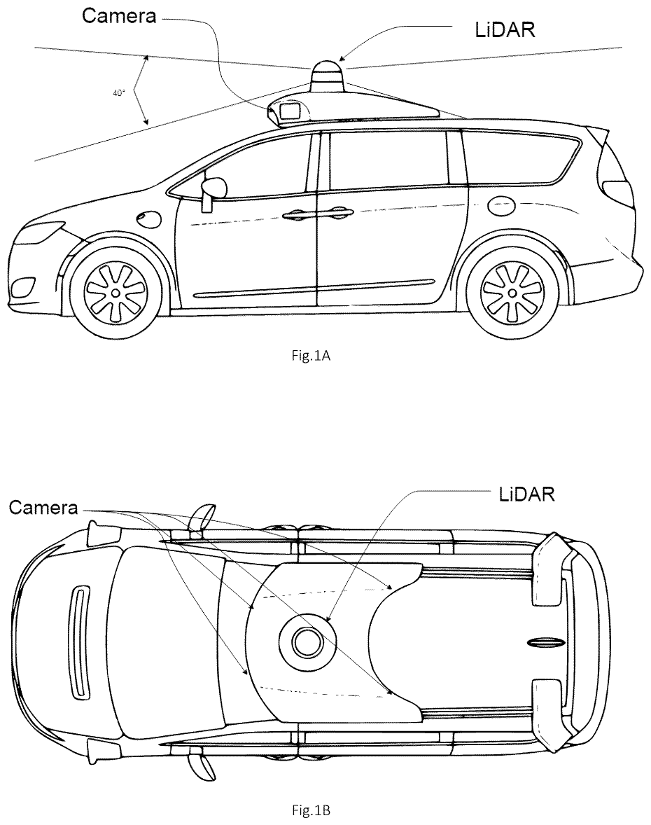

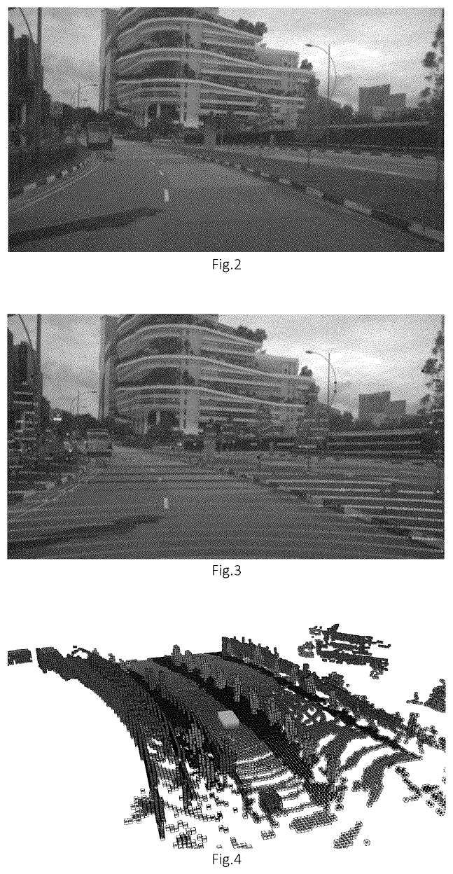

### DETAILED DESCRIPTION OF THE INVENTION

The present invention provides a system and method for generating a dense, visibility-aware 3D occupancy grid using LiDAR data for autonomous driving applications. This invention is designed to enhance spatial perception in autonomous vehicles by creating a high-resolution, semantically rich occupancy grid that includes both common and general objects, accommodating complex, unstructured environments.

The system comprises three main stages: voxel densification, occlusion reasoning, and image-guided voxel refinement. These stages interact to transform sparse LiDAR data into a detailed 3D occupancy grid that captures the semantic and geometric attributes of the environment.

Voxel Densification from Sparse LiDAR Scans: The initial stage, voxel densification, aims to mitigate the inherent sparsity of LiDAR data by aggregating multiple frames and using algorithmic techniques to enhance voxel density and labeling precision.

Multi-Frame Aggregation:
a. Data Aggregation: The system begins by capturing a sequence of LiDAR point clouds over several frames. Each frame captures sparse point clouds due to the limitations of LiDAR scanning range and density, especially at greater distances. To overcome this sparsity, the system aggregates points from multiple frames into a single point cloud representation.
b. Dynamic vs. Static Object Separation: Dynamic objects, such as vehicles and pedestrians, are separated from static background elements, such as buildings and road signs, during the aggregation process. Dynamic objects are handled independently to avoid motion artifacts, ensuring that moving objects are accurately represented without distortion.
c. Coordinate Transformation: For each dynamic object, the system transforms its coordinates from sensor space to object-specific coordinates, ensuring alignment across frames. For static background objects, the system aggregates points directly in a global coordinate system.

Combined Voxel Representation: Once dynamic and static objects are aggregated, they are fused into a single dense voxel grid, significantly increasing the spatial resolution and completeness of the representation.
a. Semantic Label Propagation with K-Nearest Neighbors (KNN):
   i. Label Assignment: After voxel densification, each point in the aggregated point cloud is assigned a semantic label representing its object category (e.g., pedestrian, vehicle, road sign). Since manually labeling each point in every frame is impractical, the system employs a KNN algorithm to assign labels.
   ii. Unlabeled Point Assignment: For each unlabeled point in the aggregated grid, the KNN algorithm finds the nearest labeled points and assigns the most common label among them. This approach propagates semantic information throughout the grid, creating a more semantically rich representation.
   iii. Handling Sparse Regions: For sparsely populated regions, the KNN algorithm ensures that the majority labels are propagated consistently, enhancing the reliability of the grid's semantic structure.
b. Mesh Reconstruction for Surface Continuity:
   i. Point Cloud Hole Filling: Even with multi-frame aggregation, certain objects may still exhibit gaps due to sparse LiDAR coverage. To address this, the system performs mesh reconstruction on the aggregated point cloud. This technique generates a continuous surface model by filling in holes on object surfaces.
   ii. Mesh Fusion Using Volumetric Methods: For non-ground objects, volumetric surface reconstruction (e.g., VDBFusion or truncated signed distance functions, TSDF) is applied to generate smooth, dense surfaces. This process is particularly effective for handling complex object geometries.
   iii. Voxel Sampling: After mesh reconstruction, dense point sampling is performed within each voxel, further refining the grid's density and enabling high-quality occupancy labeling.

Occlusion Reasoning for Visibility Determination: the occlusion reasoning stage determines which voxels in the 3D grid are visible, occupied, or unobserved. This stage is crucial for accurately representing the spatial occupancy state of each voxel, as it incorporates both LiDAR and camera data to distinguish between occluded and non-occluded regions.
a. LiDAR Ray-Casting for Visibility Analysis:
   i. Ray-Casting Algorithm: The system uses a ray-casting algorithm to simulate LiDAR beam paths, traversing each voxel in a straight line from the LiDAR origin. Each voxel that the ray intersects is classified based on whether it reflects the LiDAR beam.
   ii. Voxel Classification: (1) Occupied Voxel: If a voxel reflects a LiDAR beam, it is marked as “occupied.” (2) Free Voxel: Voxels traversed by the LiDAR beam without reflection are labeled “free,” indicating empty or traversable space. (3) Unobserved Voxel: Voxels not intersected by any LiDAR beam are labeled “unobserved,” as their occupancy state remains unknown.
   iii. Dynamic Visibility Masking: As each LiDAR point is processed, the system updates the visibility state for each voxel dynamically, ensuring that the occupancy grid remains consistent with the real-time environment.
b. Voxel State Refinement with 3D-2D Consistency:
   i. Cross-Referencing with Camera Data: The system utilizes 2D image data to cross-reference voxel states, checking for consistency between 3D occupancy and 2D projections. If discrepancies are detected (e.g., an object edge that appears occupied in 2D but is free in 3D), adjustments are made to refine the voxel state.
   ii. Visibility Mask Updates: Voxels that appear occupied in LiDAR but unobserved in the camera view are marked accordingly, allowing the system to handle complex visibility conditions effectively.

Image-Guided Voxel Refinement for Enhanced Accuracy: The final stage, image-guided voxel refinement, improves the fidelity of the 3D occupancy grid by refining voxel boundaries and correcting any inaccuracies due to LiDAR noise or alignment errors.
a. Pixel-to-Voxel Mapping:
   i. Projection Mapping: Each image pixel is mapped to its corresponding 3D voxel, allowing the system to compare the semantic label of each voxel with its corresponding pixel in the 2D image. This mapping provides fine-grained alignment between the 2D and 3D representations.
   ii. Boundary Refinement: For voxels at object boundaries, the system adjusts voxel labels to match the pixel's semantic information, correcting any boundary misalignment due to LiDAR sensor noise.
b. Voxel State Adjustment Using Image Semantics:
   i. Semantic Consistency Check: If a voxel's label differs significantly from its corresponding 2D pixel label (e.g., a voxel labeled as “free” but observed as part of an object in the image), the system updates the voxel state to match the image semantics.
   ii. Boundary Detail Preservation: This refinement process preserves object boundary details, ensuring that irregular shapes and fine structures, such as the protruding arm of a construction vehicle, are accurately represented in the occupancy grid.
c. Enhanced Object Recognition and General Object Handling:
   i. General Object Representation: The system is capable of detecting and representing “general objects” that do not belong to pre-defined categories in the dataset. By using voxel and pixel consistency, the system identifies and labels unknown objects in the environment.
   ii. Clustering Algorithm for Unknown Objects: A clustering algorithm is applied to group unrecognized voxels, forming a unified label for each general object. These labeled clusters enable the autonomous system to recognize and react to unanticipated objects, improving navigational safety in unpredictable environments.

1. A system for A system for acquiring a dense 3D occupancy grid from LiDAR data for autonomous driving, comprising a voxel densification module that aggregates LiDAR points across multiple frames and assigns semantic labels using a K-nearest neighbors algorithm to produce a dense voxel representation, an occlusion reasoning module that performs ray-casting on LiDAR data to classify each voxel as occupied, free, or unobserved, based on beam reflections and traversal paths, and an image-guided refinement module that adjusts voxel states by mapping 2D image pixels to corresponding 3D voxels, ensuring alignment and correcting boundary details for high-accuracy occupancy representation.
A method for generating a 3D occupancy grid from sequential LiDAR scans, comprising aggregating LiDAR data over multiple frames to increase voxel density and separate dynamic from static objects in the occupancy grid, applying a ray-casting algorithm to determine voxel states, labeling voxels as occupied, free, or unobserved based on LiDAR beam interactions, and refining voxel boundaries by mapping image pixel labels to voxel states, ensuring consistency with observed 2D image data for enhanced object boundary fidelity.
A method of semantic label propagation within a 3D voxel grid, comprising assigning semantic labels to aggregated LiDAR points using a K-nearest neighbors approach for label continuity across sparsely populated regions and conducting mesh reconstruction on aggregated point clouds to fill in sparse areas, ensuring continuous surface representation in the voxel grid.
A system for handling general objects in autonomous vehicle perception, comprising a clustering algorithm applied to unlabeled or out-of-vocabulary voxels in the 3D occupancy grid, creating cohesive representations for unrecognized objects, and a labeling process that assigns a unified label to clustered unknown objects, allowing autonomous systems to identify and respond to unpredictable objects in the environment.
A visibility-aware 3D occupancy grid generation system, comprising a LiDAR ray-casting module that dynamically updates voxel visibility states as occupied, free, or unobserved, and an image-guided refinement module that incorporates 2D image semantics to refine voxel states, preserving object boundaries and adjusting for LiDAR misalignments.
